(19) United States
(12) Patent Application Publication
(10) Pub. No.: US 2026/0173207 A1
(43) Pub. Date: Jun. 18, 2026

(54) METHOD FOR TRANSMITTING AND RECEIVING PAGING MESSAGES IN NR-U ENVIRONMENT, AND APPARATUS USING THE METHOD THEREOF

(71) Applicant: Research & Business Foundation Sungkyunkwan University, Suwon-si (KR)

(72) Inventors: Jaehoon JEONG, Busan (KR); Eshita RASTOGI, Suwon-si (KR)

(73) Assignee: Research & Business Foundation Sungkyunkwan University, Suwon-si (KR)

(21) Appl. No.: 19/423,336

(22) Filed: Dec. 17, 2025

(30) Foreign Application Priority Data
Dec. 17, 2024 (KR) 10-2024-0188734

(51) Int. Cl. H04W 76/28; H04W 68/02

(52) U.S. Cl. CPC H04W 76/28; H04W 68/02

(57) ABSTRACT

The present disclosure relates to a technology for transmitting and receiving a paging message in a new radio-unlicensed (NR-U) environment, and according to an embodiment of the present disclosure, a method performed by a base station (BS) includes scheduling a paging occasion (PO) according to a discontinuous reception (DRX) cycle of user equipment (UE), transmitting DRX-related information including information about the PO and a paging frame (PF) to the UE through radio resource control (RRC) signaling, transmitting a paging message to the UE based on the DRX-related information, and scheduling a next PO based on the PO, wherein the next PO includes a backup PO scheduled by the BS after maximum channel occupancy time (MCOT) has elapsed after the PO, when the UE fails to receive the paging message during the PO.

### CROSS-REFERENCE TO RELATED APPLICATIONS

This application claims the benefit of Korea Patent Application No. 10-2024-0188734, filed on Dec. 17, 2024, which is incorporated herein by reference for all purposes as if fully set forth herein.

### TECHNICAL FIELD

The present disclosure relates to a paging mechanism in a wireless communication environment, particularly in a new radio (NR) unlicensed spectrum (NR-U) environment for an NR, which is a fifth-generation (5G) mobile communication technology, and more specifically, to a technology for improving the paging efficiency of an NR-U system through additional fast paging and backup paging occasions in addition to typical full paging for delay-sensitive user equipment.

### BACKGROUND

A fifth-generation (5G) mobile communication technology features ultra-high speeds, ultra-low delay, and hyper-connectivity and has been designed to support various service requirements, such as enhanced mobile broadband (eMBB), ultra-reliable low delay communications (URLLC), massive machine type communications (mMTC), etc. In particular, services, such as URLLC, require millisecond-level delay and high reliability, necessitating technologies differentiated from those of conventional fourth-generation (4G) long term evolution (LTE). This technological advancement has enabled new applications, such as an autonomous vehicle, remote healthcare, smart manufacturing, etc.

Technologies for delay-sensitive user equipment are essential in 5G networks. The URLLC is a technology developed to achieve extremely low delay and high reliability in network design and adopts efficient resource management and packet scheduling techniques. In addition, 5G networks provide an adaptive discontinuous reception (DRX) cycle for delay-sensitive user equipment, which ensures fast response while minimizing the energy consumption of the terminal. These technologies have evolved to meet the performance requirements of time-sensitive applications.

listen before talk (LBT) used in NR-U is a technology designed to ensure fair channel access in unlicensed spectrum. The LBT includes a procedure for verifying channel availability before transmitting and allows transmission only when the channel is free.

Paging is a critical procedure used by the network to activate user equipment (UE) in a sleep mode. In a typical paging mechanism, the UE wakes up at predefined paging occasions and receives paging messages from the network. This is performed periodically to improve energy efficiency for the terminal, and in 5G NR, paging messages are transmitted via directional beam sweeping. However, the beam sweeping requires multiple time slots, and in an NR-U environment, paging message transmission can be delayed depending on the success or failure of the LBT procedure. Such a problem can increase paging delay and lead to the inefficient use of network resources.

### SUMMARY

Conventional new radio-unlicensed (NR-U) systems adopt a listen before talk (LBT) procedure for communication in unlicensed spectrum, but a failure to check channel occupancy results in communication delays. Such delay, in particular, hinders the reception of paging messages by time-sensitive user equipment (UE), thereby degrading the reliability of the system. In addition, due to the directional transmission characteristics of NR systems, paging messages need to be transmitted in multiple directions through beam sweeping, which increases the resource consumption of network base station equipment (gNodeB, gNB) and results in additional delay in the overall paging procedure. In addition, the related art fails to adequately reflect the different requirements of delay-sensitive UEs and typical UEs, resulting in an inability to provide fast and efficient responses to UEs using time-sensitive applications. Consequently, there is a need for an optimized mechanism to minimize paging delay and improve resource efficiency in the NR-U systems.

According to a first embodiment of the present disclosure, there is provided a method of transmitting a paging message in a new radio-unlicensed (NR-U) environment, which is performed by a base station (BS), the method including scheduling a paging occasion (PO) according to a discontinuous reception (DRX) cycle of user equipment (UE), transmitting DRX-related information including information about the PO and a paging frame (PF) to the UE through radio resource control (RRC) signaling, transmitting a paging message to the UE based on the DRX-related information, and scheduling a next PO based on the PO. The next PO includes a backup PO scheduled by the BS after maximum channel occupancy time (MCOT) has elapsed after the PO, when the UE fails to receive the paging message during the PO.

The scheduling of the next PO may include determining, through a discrete-time semi-Markov chain, whether paging or backup paging is required for the UE at the next PO based on the PO immediately before the next PO.

The scheduling of the next PO may include receiving beam information from the UE immediately before the next PO, scheduling a fast PO based on the PO and the beam information, and transmitting a fast paging message to the UE based on the fast PO. The beam information may include at least one of reference signal received power (RSRP), reference signal received quality (RSRQ), and a signal to interference plus noise ratio (SINR).

The scheduling of the next PO may further include scheduling a backup fast PO after the MCOT has elapsed after the fast PO, when the UE fails to receive the fast paging message during the fast PO.

The fast paging message may be transmitted to the UE through a beam selected based on the beam information.

According to a second embodiment of the present disclosure, there is provided a base station (BS) for transmitting a paging message in a new radio-unlicensed (NR-U) environment, the BS including one or more transceivers, one or more processors, and one or more memories configured to store instructions for operations executed by the processors.

In the processor, the operations may include scheduling a paging occasion (PO) according to a discontinuous reception (DRX) cycle of user equipment (UE), transmitting DRX-related information including information about the PO and a paging frame (PF) to the UE through radio resource control (RRC) signaling, transmitting a paging message to the UE based on the DRX-related information, and scheduling a next PO based on the PO. The next paging occasion may include a backup PO scheduled by the BS after maximum channel occupancy time (MCOT) has elapsed after the PO, when the UE fails to receive the paging message during the PO.

Among the operations performed by the processor, the scheduling of the paging occasion may include determining, through a discrete-time semi-Markov chain, whether paging or backup paging is required for the UE at the next PO based on the PO immediately before the next PO.

Among the operations performed by the processor, the scheduling of the next PO may include receiving beam information from the UE immediately before the next PO, scheduling a fast PO based on the PO and the beam information, and transmitting a fast paging message to the UE based on the fast PO. The beam information may include at least one of reference signal received power (RSRP), reference signal received quality (RSRQ), and a signal to interference plus noise ratio (SINR). The fast paging message may be transmitted to the UE through a beam selected based on the beam information.

Among the operations performed by the processor, the scheduling of the next paging occasion may further include scheduling a backup fast PO after the MCOT has elapsed after the fast PO, when the UE fails to receive the fast paging message during the fast PO.

According to a third embodiment of the present disclosure, there is provided a method of receiving a paging message in a new radio-unlicensed (NR-U) environment, which is performed by user equipment (UE), including receiving discontinuous reception (DRX)-related information including information about a paging occasion (PO) and a paging frame (PF) from a base station (BS) through radio resource control (RRC) signaling, receiving a paging message from the BS based on the DRX-related information, and receiving a next paging message from the BS according to a next PO scheduled based on the PO. The next PO may include a backup PO scheduled by the BS after maximum channel occupancy time (MCOT) has elapsed after the PO, when the UE fails to receive the paging message during the PO. The next paging message may include a backup paging message received from the BS based on the backup PO.

The receiving of the next paging message from the BS may further include transmitting beam information to the BS immediately before the next PO, and receiving a fast paging message from the BS according to a fast PO scheduled based on the PO and the beam information. The beam information May include at least one of reference signal received power (RSRP), reference signal received quality (RSRQ), and a signal to interference plus noise ratio (SINR).

The fast paging message may be received from the BS through a beam selected by the BS based on the beam information.

According to a fourth embodiment of the present disclosure, there is provided user equipment (UE) for receiving a paging message in a new radio-unlicensed (NR-U) environment, including one or more transceiver, one or more processors, and one or more memories configured to store instructions for operations executed by the processors.

In the processor, the operations may include receiving discontinuous reception (DRX)-related information including information about a paging occasion (PO) and a paging frame (PF) from a base station (BS) through radio resource control (RRC) signaling, receiving a paging message from the BS based on the DRX-related information, and receiving a next paging message from the BS according to a next PO scheduled based on the PO. The next PO may include a backup PO scheduled by the BS after maximum channel occupancy time (MCOT) has elapsed after the PO, when the UE fails to receive the paging message during the PO. The next paging message may include a backup paging message received from the BS based on the backup PO.

Among the operations performed by the processor, the receiving of the next paging message from the BS may further include transmitting beam information to the BS immediately before the next PO, and receiving a fast paging message from the BS according to a fast PO scheduled based on the PO and the beam information. The beam information may include at least one of reference signal received power (RSRP), reference signal received quality (RSRQ), and a signal to interference plus noise ratio (SINR). The fast paging message may be received from the BS through the beam selected by the BS based on the beam information.

Among the operations performed by the processor, the receiving of the next paging message from the BS may further include receiving a backup fast paging message from the BS according to a backup fast PO scheduled by the BS after the MCOT has elapsed after the fast PO, when the UE fails to receive the fast paging message during the fast PO.

One embodiment of the present disclosure can provide the paging procedure optimized for delay-sensitive UEs and typical UEs by combining full paging and fast paging.

In addition, the backup PO can reduce paging delay and improve the resource utilization of the base station even when the LBT procedure fails.

### BRIEF DESCRIPTION OF THE DRAWINGS

The accompanying drawings, which are included as part of the detailed description to help understanding of the present disclosure, provide embodiments of the present disclosure and describe the contents of the present disclosure together with the detailed description, in which:

FIG. 1 is a view illustrating an environment in which new radio-unlicensed (NR-U) and Wi-Fi coexist to describe communication in an NR-U environment;

FIG. 2 is a view for describing discontinuous reception (DRX);

FIG. 3 is a view illustrating a typical paging mechanism;

FIG. 4 is a view illustrating each method performed by a base station according to an embodiment of the present disclosure;

FIG. 5 is a view illustrating a method performed by the base station according to the embodiment of the present disclosure in chronological order,

FIG. 6 is a view illustrating a process in which the base station schedules and transmits fast paging messages according to the embodiment of the present disclosure in chronological order;

FIG. 7 is a view for describing a method for providing a fast paging occasion (fast PO) to delay-sensitive user equipment (UE);

FIG. 8 is a view illustrating an example of modeling a paging mechanism using a semi-Markov chain according to the embodiment of the present disclosure;

FIG. 9 is a view illustrating an example of modeling a paging mechanism including backup paging using the semi-Markov chain according to the embodiment of the present disclosure;

FIGS. 10 to 12 are views illustrating the results of simulating paging resource usage according to the number of UEs in various configurations including the paging mechanism according to the embodiment of the present disclosure;

FIGS. 13 and 14 are views illustrating the results of simulating paging delay usage according to the number of UEs in various configurations including the paging mechanism according to the embodiment of the present disclosure;

FIG. 15 is a block diagram illustrating the base station and the UE according to the embodiment of the present disclosure.

### DETAILED DESCRIPTION

In describing the embodiments of the present disclosure, when it is determined that detailed description of known technologies related to the present disclosure may unnecessarily obscure the gist of the embodiments, the detailed description thereof will be omitted. In addition, the following terms are the terms defined in consideration of functions in the present disclosure, which may vary depending on the intention, custom, etc. of a user or an operator. Accordingly, the definition should be made based on the contents throughout the present disclosure. The terms used in the detailed description are only for the purpose of describing the embodiments of the present disclosure and should never be construed in a limited manner. Unless clearly used otherwise, expressions in the singular form include plural meanings. In this description, the terms such as “including” or “having” are intended to indicate certain characteristics, numbers, steps, operations, elements, or some or a combination thereof, and should not be construed to exclude the presence or possibility of one or more other characteristics, numbers, steps, operations, elements, or some or a combination thereof other than those described.

The terms including ordinal numbers, such as “first,” “second,” etc., may be used to describe various components, but the components are not limited by the terms. The terms may only be used in a nominal sense to distinguish one component from another, and their ordinal meaning is determined not from the names but from the context of the description.

The term “and/or” is used to include any combination of multiple target items. For example, the term “A and/or B” includes all three cases: “A,” “B,” and “A and B.”

When a certain component is described as being “connected” or “coupled” to the other component, it should be understood that the certain component may be directly connected or coupled to the other component or another component may be present therebetween.

Unless especially defined otherwise, all terms used herein, including technical or scientific terms, have the same meaning as commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in the present disclosure.

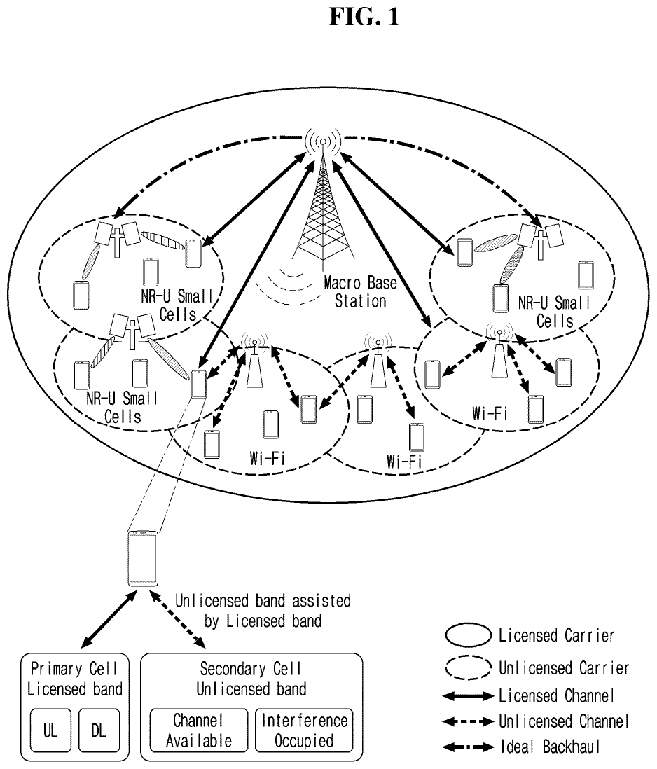

FIG. 1 is a view illustrating an environment in which new radio-unlicensed (NR-U) and Wi-Fi coexist to describe communication in an NR-U environment.

Referring to FIG. 1, it can be confirmed that unlicensed carrier ranges for NR-U and Wi-Fi overlap and coexist.

A fifth-generation (5G) mobile communication technology (new radio (NR)) features ultra-high speeds, ultra-low delay, and hyper-connectivity and has been designed to support various service requirements, such as enhanced mobile broadband (eMBB), ultra-reliable low delay communications (URLLC), massive machine type communications (mMTC), etc. In particular, services, such as URLLC, require millisecond-level delay and high reliability, necessitating technologies differentiated from those of conventional fourth-generation (4G) long term evolution (LTE).

Technologies for delay-sensitive user equipment are essential in 5G networks. The URLLC is a technology developed to achieve extremely low delay and high reliability in network design and adopts efficient resource management and packet scheduling techniques. In addition, the 5G networks provide an adaptive discontinuous reception (DRX) cycle for delay-sensitive user equipment (UE), which ensures fast response while minimizing the energy consumption of the UE.

The NR-U has been designed to allow conventional cellular networks to use unlicensed spectrum. This enables coexistence between mobile networks and conventional unlicensed technologies, such as Wi-Fi, and expands the capacity of 5G networks by securing additional frequency resources. The NR-U uses a listen before talk (LBT) technology to ensure fair channel access and support efficient communication across various frequency bands. However, due to the characteristics of the unlicensed spectrum, delay may be caused by a failure of the LBT procedure, which can degrade the performance of the paging procedure for delay-sensitive devices.

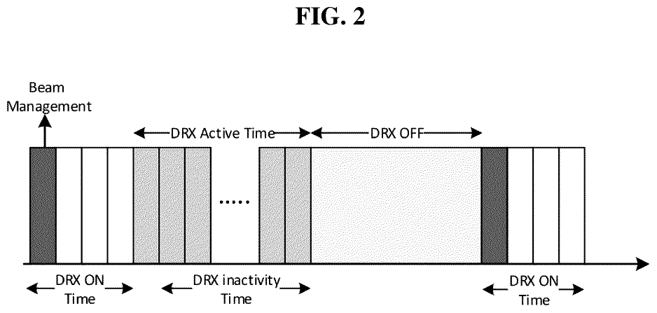

FIG. 2 is a view for describing discontinuous reception (DRX).

Referring to FIG. 2, a typical DRX mechanism is illustrated. The DRX is a technology defined by 3GPP to reduce the energy consumption of a UE, is configured through a radio resource control (RRC) protocol, and allows the UE to receive network signals only at specific intervals. The DRX cycle has been designed to minimize battery consumption of the UE in a standby state and simultaneously receive network signals at regular intervals to prevent the loss of important messages, such as paging. A length of the DRX may be adjusted based on the requirements of the UE, and a shorter DRX cycle is used for delay-sensitive UEs. In the NR-U environment, the LBT procedure needs to be performed within the DRX cycle, and thus interaction between the DRX and the LBT significantly impacts system performance.

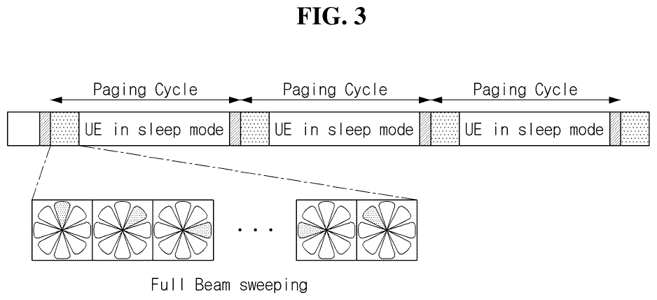

FIG. 3 is a view illustrating a typical paging mechanism.

Referring to FIG. 3, a red area indicates the time of a paging request, and a blue area indicates a PO.

The paging is a critical procedure used by networks to activate a UE in a sleep mode, and in the typical paging mechanism, the UE wakes up at predefined POs and receives paging messages from the network. This is performed periodically to improve energy efficiency for the terminal, and in 5G NR, paging messages are transmitted via directional beam sweeping. This is illustrated in a “Full Beam Sweeping” part of FIG. 3. However, the beam sweeping in all directions requires multiple time slots, and in the NR-U environment, the transmission of the paging messages may be delayed depending on the success or failure of the LBT procedure. Such a problem can increase paging delay and lead to the inefficient use of network resources.

Various embodiments of the present disclosure may provide an efficient paging mechanism for delay-sensitive UEs in the NR-U environment, thereby contributing to minimizing paging delay and maximizing network resource utilization.

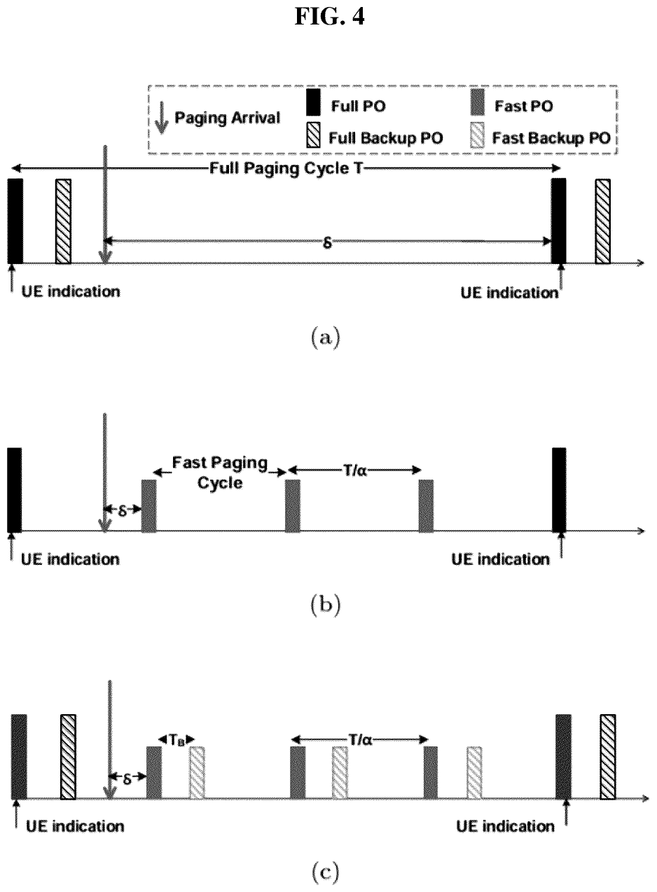

FIG. 4 is a view illustrating each method performed by a base station (BS) according to an embodiment of the present disclosure.

Referring to FIG. 4A, it can be confirmed that a “Full Backup PO” (i.e., a backup PO) is present between “Full POs,” which represent typical POs. This is to solve the problem of having to wait for a next PO, that is, a paging cycle, when the UE fails to receive a paging message during a specific PO, and by providing the backup PO between the typical POs, paging delay can be resolved.

Referring to FIG. 4B, it can be confirmed that the BS provides the UE with a “Fast PO” (i.e., a fast PO) between “Full POs.” In this case, the fast PO may be particularly a PO for delay-sensitive UEs. Accordingly, to reduce delay, the BS may receive beam information from the UE immediately before the fast PO, select an optimal beam based on the beam information, and then perform beam sweeping using only the selected beam to provide the fast paging message.

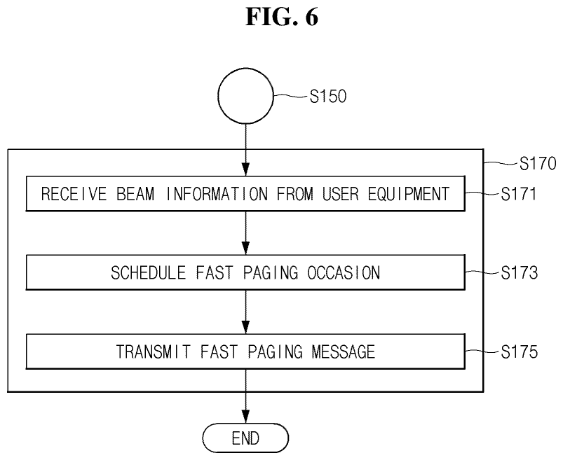

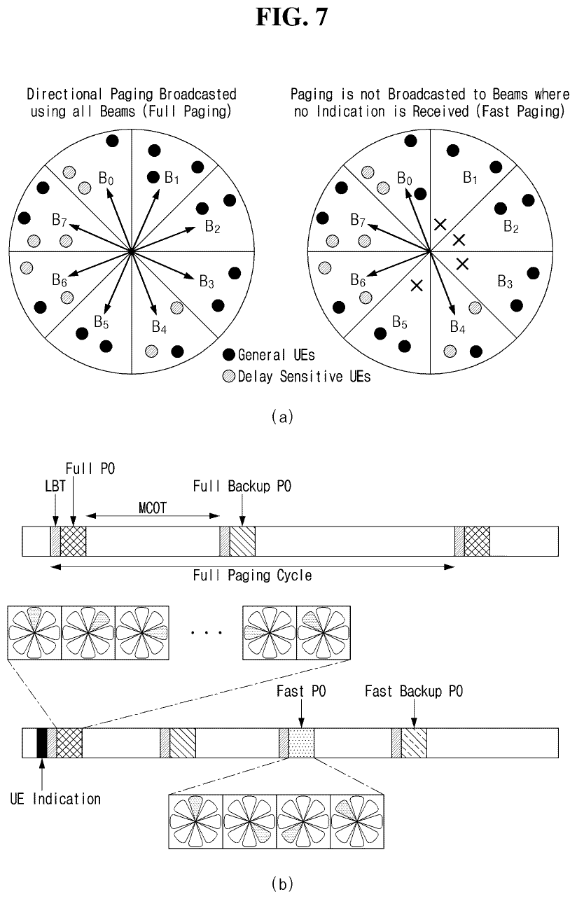

Referring to FIG. 4C, it can be confirmed that the methods proposed in FIGS. 4A and 4B, respectively, are combined. Accordingly, the BS may provide the UE with a backup PO and a “Fast Backup PO” (i.e., a backup fast PO) after a “Full PO” and a fast PO, respectively. More detailed descriptions thereof will be provided in FIGS. 6 and 7.

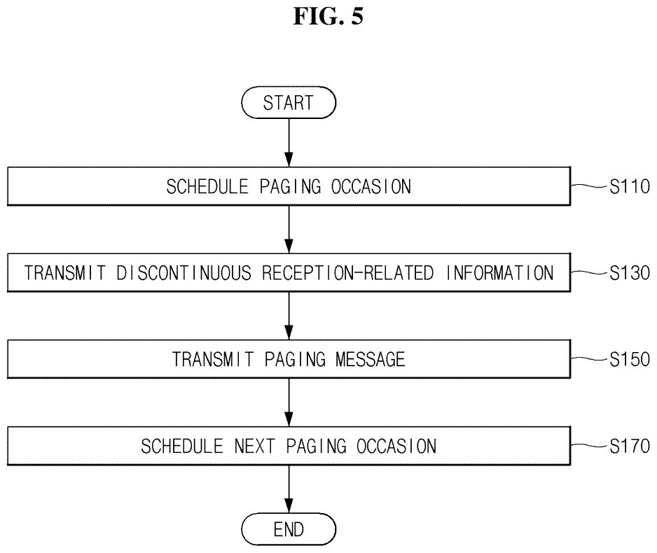

FIG. 5 is a view illustrating a method performed by the BS according to the embodiment of the present disclosure in chronological order.

Referring to FIG. 5, in operation S110, the BS may schedule POs according to the DRX cycle of the UE.

In operation S130, the BS may transmit DRX-related information including information about a PO and a paging frame (PF) to the UE through radio resource control signaling.

In operation S150, the BS may transmit the paging messages to the UE based on the DRX-related information.

In operation S170, the BS may schedule a next PO based on the PO. In this case, the next PO may include a backup PO scheduled by the BS after maximum channel occupancy time (MCOT) has elapsed after the PO, when the UE fails to receive the paging message during the PO.

The MCOT is a rule that limits channel occupancy time to ensure coexistence between NR-U and Wi-Fi, enabling fair and efficient use of spectrum resources. In an NR-U system, the MCOT defines the maximum time a BS may exclusively occupy the channel, and when this time is exceeded, the LBT procedure needs to be reperformed.

In another embodiment, the BS may additionally schedule a fast PO as the next PO. The scheduling of the fast PO by the BS will be described in more detail with reference to FIG. 6.

FIG. 6 is a view illustrating a process in which the BS schedules and transmits fast paging messages according to the embodiment of the present disclosure in chronological order.

Referring to FIG. 6, in operation S171, the BS may receive beam information from the UE immediately before the next PO. In this case, the beam information may be a reference signal-based measurement value or interference and noise-related information.

In addition, the beam information may include at least one of the reference signal-based measurement values including reference signal received power (RSRP) and reference signal received quality (RSRQ), and the interference and noise-related information including a signal to interference plus noise ratio (SINR).

In operation S173, the BS may schedule a fast PO based on the PO and the beam information.

In operation S175, the BS may transmit the fast paging message to the UE based on the fast PO.

According to another embodiment, after operation S175, the BS may further include scheduling a backup fast PO after the MCOT has elapsed after the fast PO, when the UE does not receive the fast paging message during the fast PO, and thereafter, the BS may transmit the backup fast paging message to the UE based on the backup fast PO.

In addition, the fast paging message may be transmitted to the UE by the BS through the beam selected based on the beam information. This will be described in more detail with reference to FIG. 7.

FIG. 7 is a view for describing a method for providing a fast paging occasion (fast PO) to delay-sensitive user equipment (UE);

Referring to FIG. 7A, typical UEs are represented by blue dots, and delay-sensitive UEs are represented by green dots. The fast PO may be particularly a paging mechanism for delay-sensitive UEs, but is not limited thereto, and may of course be applied to the typical UEs as well. In the description of FIG. 7, for clarity, an example in which the BS provides the fast PO to delay-sensitive UEs will be described.

The BS may receive the beam information from each of the delay-sensitive UEs. In this case, the BS may select an optimal beam for the corresponding UEs based on any one of RSRP, RSRQ, and SINR included in the beam information.

Hereafter, referring to FIG. 7B, the BS may schedule fast POs based on the beam information and transmit a fast paging message to the UE by performing beam sweeping only with the selected optimal beam.

When the UE fails to receive the fast paging message during the fast PO, the backup fast paging message transmitted to the UE according to the scheduled backup fast PO may also be transmitted to the UE through the optimal beam selected based on the beam information in the same manner as the fast paging message.

According to another embodiment, the scheduling of the next PO may further include determining, through a discrete-time semi-Markov chain, whether paging or backup paging is required for the UE at the next PO based on the PO immediately before the next PO.

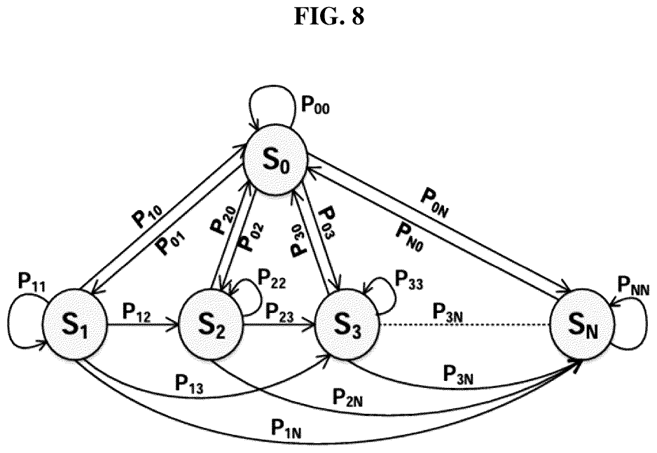

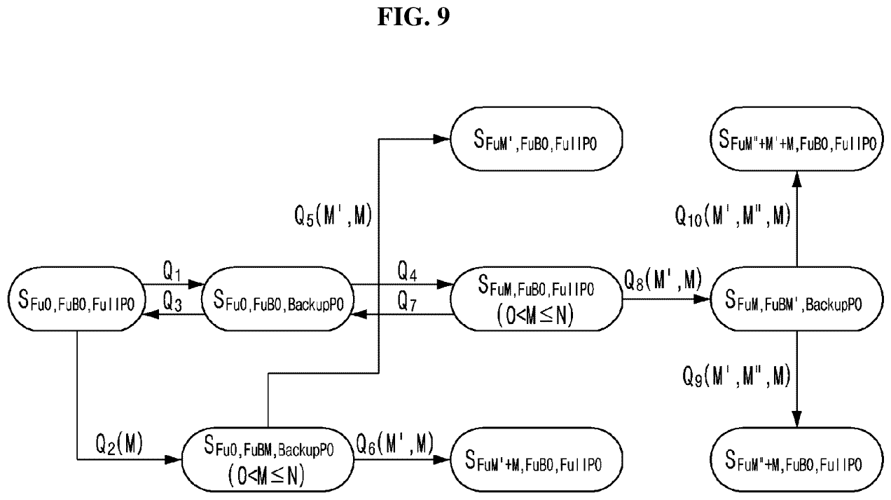

The discrete-time semi-Markov chain is used to define the transition probability from one state to another and used so that the determination of the number of UEs requiring paging at a given PO depends only on the PO immediately before the specific PO rather than on any previous POs. In this case, the state may be updated at the end of each PO, and the transition time from one state to the next may be fixed to the paging cycle of the UE. The detailed descriptions of the paging mechanism modeling using the discrete-time semi-Markov chain will be provided with reference to FIGS. 8 and 9.

FIG. 8 is a view illustrating an example of modeling a paging mechanism using a semi-Markov chain according to the embodiment of the present disclosure and specifically illustrates a paging mechanism without a backup PO.

The paging mechanism illustrated in FIG. 8 may be applied to both a paging mechanism based on a typical PO and a fast paging mechanism based on the fast PO, and in the fast paging mechanism, the paging cycle T is changed to T/α In this case, α denotes an interval between fast POs, that is, a fast paging cycle factor (FPCF). In addition, in the fast paging mechanism, the number of UEs changes from N to N′=σN and is 0<σ<1.

Paging requests for each UE follow a Poisson process with an arrival rate λ, and a downlink (DL) LBT success probability is denoted by ρ. Downlink transmission is possible only when the LBT procedure performed by the BS is successful, and otherwise, the UE needs to wait until the LBT procedure is successful.

In FIG. 8, a state S_{M} (0≤M≤N) indicates that the BS needs to transmit paging messages to M UEs in the next PO. The state of the BS is updated at the end of each PO. Considering Poisson arrivals, a probability that no paging request occurs for the UE during a paging cycle is e^{-λT}, and a probability that at least one paging request occurs for the UE during the paging cycle is 1−e^{-λT}. A transition probability from state Sᵢ to state Sj is denoted by Pᵢⱼ. A state transition S₀→S₀ from S0 to S₀ occurs only in two cases: when no paging request occurs during time T, and when a paging request occurs for at least one UE but the downlink LBT succeeds at the next PO. Accordingly, a transition probability Poo may be represented by the following equation.

$${P}_{00} = {e}^{- λ NT} + ( 1 - {e}^{- λ NT} ) ρ \qquad [ Equation 1 ]$$

A transition S₀→S_{M} (0≤M≤N) from S₀ to S_{M} occurs when paging arrivals occur for M UEs during time T and the downlink LBT fails at the next PO. The paging arrival probability for M UEs during time T may be denoted by ^{N}C_{M} (1−e^{-λT})^{M} (e^{-λT})^{N-M}, where ^{N}C_{M} denotes the number of possible combinations in which M UEs are selected from N UEs. Since the probability that the downlink LBT fails is (1−φ, the transition probability Pom (0≤M≤N) may be represented by the following equation.

$${P}_{0 M} {=}^{N} {{C}_{M} ( 1 - {e}^{- λ T} )}^{M} {( {e}^{- λ T} )}^{N - M} ( 1 - ρ ) \qquad [ Equation 2 ]$$

A transition S_{M}→S₀ (0≤M≤N) from S_{M} to S₀ occurs when the downlink LBT succeeds at the next PO. Accordingly, a transition probability P_{M0} is denoted by ρ.

When 0≤M≤N and M≤M′≤N, a transition S_{M}→S_{M}, from S_{M} to S_{M′} occurs when at least one UE receives a paging message during time T and the downlink LBT fails at the next PO. Accordingly, a transition probability P_{MM′} may be represented by the following equation.

$${P}_{{MM}^{′}} = {( 1 - ρ )}^{N - M} {{C}_{{M}^{′} - M} ( 1 - {e}^{- λ T} )}^{{M}^{′} - M} {( {e}^{- λ T} )}^{N - {M}^{′}} \qquad [ Equation 3 ]$$

Assuming that a steady-state probability of the semi-Markov chain for state S_{M} (0≤M≤N) is

$${π}_{{Fu}_{M}} , {π}_{{Fu}_{0}}$$

may be calculated through the following equation based on a balance equation.

$${π}_{{Fu}_{0}} = {π}_{{Fu}_{0}} {P}_{00} + {π}_{1} {P}_{10} + {π}_{2} {P}_{20} + … + {π}_{N} {P}_{N0} = {π}_{{Fu}_{0}} {P}_{00} + ρ {\sum }_{n = 1}^{N} {π}_{n} \qquad [ Equation 4 ]$$

By substituting the P₀₀ value from Equation 1 into Equation 4, and using

$${\sum }_{n = 0}^{N} {π}_{n} = 1 , {π}_{{Fu}_{0}}$$

may be calculated using the following equation.

$${π}_{{Fu}_{0}} = \frac{ρ}{1 - ( 1 - ρ ) {e}^{- λ NT}} \qquad [ Equation 5 ]$$

Next, based on the balance equation,

$${π}_{{Fu}_{M}}$$

may be calculated using the following Equation 6.

$${π}_{{Fu}_{1}} = {π}_{{Fu}_{0}} {P}_{01} + {π}_{{Fu}_{1}} {P}_{11} \qquad [ Equation 6 ]$$

$${π}_{{Fu}_{2}} = {π}_{{Fu}_{0}} {P}_{02} + {π}_{{Fu}_{1}} {P}_{12} + {π}_{{Fu}_{2}} {P}_{22}$$

$${π}_{{Fu}_{3}} = {π}_{{Fu}_{0}} {P}_{02} + {π}_{{Fu}_{1}} {P}_{12} + {π}_{{Fu}_{2}} {P}_{22} + {π}_{{Fu}_{3}} {P}_{33}$$

$$⋮$$

Accordingly,

$${π}_{{Fu}_{M}}$$

may generally be represented by Equation 7.

$$\begin{matrix}{π}_{{Fu}_{M}} = {\sum }_{n = 0}^{M - 1} {π}_{{Fu}_{n}} {P}_{nM} + {π}_{{Fu}_{M}} {P}_{MM} \\ = \frac{{\sum }_{n = 0}^{M - 1} {π}_{{Fu}_{n}} {P}_{nM}}{1 - {P}_{MM}}\end{matrix} \qquad [ Equation 7 ]$$

Similarly,

$${π}_{{Fa}_{0}} and {π}_{{Fa}_{M}}$$

of the fast paging mechanism are calculated using the following Equations 8 and 9.

$${π}_{{Fa}_{0}} = \frac{ρ}{1 - ( 1 - ρ ) {e}^{- λ {N}^{′} ( T / α )}} \qquad [ Equation 8 ]$$

$${π}_{{Fa}_{M}} = \frac{{\sum }_{n = 0}^{M - 1} {π}_{{Fa}_{n}} {P}_{nM}}{1 - {P}_{MM}} ; 0 < M \leq {N}^{′} \qquad [ Equation 9 ]$$

FIG. 9 is a view illustrating an example of modeling a paging mechanism including backup paging using the semi-Markov chain according to the embodiment of the present disclosure.

State S_{Fu}_{_{M}}_{, FuB}_{_{M′}}_{,next PO type} in FIG. 9 is defined as a state in which a typical paging mechanism is required for M UEs (0<M≤N), backup paging is required for M′ UEs (0≤M′≤N), and the next PO type is either a typical PO (i.e., full PO) or a backup PO. Since state transitions depend only on the previous state and the transition time from one state to the next state is fixed to the paging cycle of the UE, this has been modeled using the discrete-time semi-Markov chain. The following Table 1 shows possible state transitions, corresponding transition events, and transition probabilities, and FIG. 9 illustrates a model of a paging mechanism including a backup paging mechanism.

TABLE 1

| State Transitions | Transition Event | Transitions Probabilities |
|---|---|---|
| {S_{Fu}_{₀}_{, FuB}_{₀}_{, FullPO}} → | No paging arrivals in time-period | Q₁ = e^{-λN(T-T}^{_{B}}⁾ + (1 − e^{-λN(T-T}^{_{B}}⁾)ρ |
| {S_{Fu}_{₀}_{, FuB}_{₀}_{, BackupPO}} | (T − T_{B}) or paging arrival for at least | |
| | 1 UE in time-period (T − T_{B}), followed | |
| | by DL LBT success at next PO | |
| {S_{Fu}_{₀}_{, FuB}_{₀}_{, FullPO}} → | Paging arrival for MUEs in time- | Q₂(M) = ^{N}C_{M}(1 − e^{-λ(T-T}^{_{B}}⁾)^{M} |
| {S_{Fu}_{₀}_{, FuB}_{_{M}}_{, BackupPO}} | period (T − T_{B}), followed by DL LBT | (e^{-λ(T-T}^{_{B}}⁾)^{N-M} (1 − ρ); |
| | failure at next PO | 0 < M ≤ N |
| {S_{Fu}_{₀}_{, FuB}_{₀}_{, BackupPO}} → | No paging arrivals in time period T_{B} | Q₃ = e^{-λNT}^{_{B}} |
| {S_{Fu}_{₀}_{, FuB}_{₀}_{, FullPO}} | | |
| {S_{Fu}_{₀}_{, FuB}_{₀}_{, BackupPO}} → | Paging arrival for M UEs in time- | Q₄(M) = ^{N}C_{M}(1 − e^{-λT}^{_{B}})^{M} (e^{-λT}^{_{B}})^{N-M}; |
| {S_{Fu}_{_{M}}_{, FuB}_{₀}_{, FullPO}} | period T_{B} | 0 < M ≤ N |
| {S_{Fu}_{₀}_{, FuB}_{_{M}}_{, BackupPO}} → | Paging arrival for MUEs in time- | Q₅(M′, M) = ^{N-M}C_{M′}(1 − e^{-λT}^{_{B}})^{M′} |
| {S_{Fu}_{_{M′}}_{, FuB}_{₀}_{, FullPO}} | period T_{B}, followed by DL LBT | (e^{-λT}^{_{B}})^{N-M-M′}ρ; |
| | success at the next PO | 0 ≤ M′ ≤ N − M, 0 < M ≤ N |
| {S_{Fu}_{₀}_{, FuB}_{_{M}}_{, BackupPO}} → | Paging arrival for M′ in time-period | Q₆(M′, M) = ^{N-M}C_{M′}(1 − e^{-λT}^{_{B}})^{M′} |
| {S_{Fu}_{_{M′+M}}_{, FuB}_{₀}_{, FullPO}} | T_{B} UEs, followed by DL LBT failure | (e^{-λT}^{_{B}})^{N-M-M′} (1 − ρ); |
| | at next PO | 0 ≤ M′ ≤ N − M, 0 < M ≤ N |
| {S_{Fu}_{_{M}}_{, FuB}_{₀}_{, FullPO}} → | No paging arrivals or paging arrival | Q₇ = ρ |
| {S_{Fu}_{₀}_{, FuB}_{₀}_{, BackupPO}} | for at least 1 UE in time-period (T − | |
| | T_{B}), followed by DL LBT success at | |
| | the next PO | |
| {S_{Fu}_{_{M}}_{, FuB}_{₀}_{, FullPO}} → | Paging arrival for M′ UEs in time- | Q₈(M′, M) = ^{N-M} C_{M′}(1 − e^{-λ(T-T}^{_{B}}⁾)^{M′} |
| {S_{Fu}_{_{M}}_{, FuB}_{_{M′}}_{, BackupPO}} | period (T − T_{B}), followed by DL LBT | (e^{-λ(T-T}^{_{B}}⁾)^{N-M-M′}(1 − ρ); |
| | failure at next PO | 0 ≤ M′ ≤ N − M, 0 < M ≤ N |
| {S_{Fu}_{_{M}}_{, FUB}_{_{M′}}_{, BackupPO}} → | Paging arrival for M″ UEs in time- | Q₉(M″, M′, M) = ^{N-M-M′}C_{M″}(1 − e^{-λT}^{_{B}})^{M″} |
| {S_{Fu}_{_{M″+M}}_{, FuB}_{₀}_{, FullPO}} | period T_{B}, followed by DL LBT | (e^{-λT}^{_{B}})^{N-M-M′-M″}ρ; |
| | success at the next PO | 0 ≤ M″ ≤ N − M − M′, 0 ≤ M′ ≤ N − M, 0 < M ≤ N |
| {S_{Fu}_{_{M}}_{, FuB}_{_{M′}}_{, BackupPO}} → | Paging arrival for M″ UEs in time- | Q₁₀(M″, M′, M) = ^{N-M-M′}C_{M″}(1 − e^{-λT}^{_{B}})^{M″} |
| {S_{Fu}_{_{M″+M′+M}}_{, FuB}_{₀}_{, FullPO}} | period T_{B}, followed by DL LBT | (e^{-λT}^{_{B}})^{N-M-M′-M″}(1 − ρ); |
| | failure at next PO | 0 ≤ M″ ≤ N − M − M′, 0 ≤ M′ ≤ N − M, 0 < M ≤ N |

As shown in Table 1, the possible states are S_{Fu}_{_{M}}_{, FuB}_{₀}_{,Full PO}, 0≤M≤N and S_{Fu}_{_{M}}_{, FuB}_{_{M′}}_{,Backup PO}, 0≤M′≤N−M, 0≤M≤N.

The steady-state distribution of the semi-Markov chain may be represented by the following Equations 10 to 15, and the balance equations for the steady-state probability using the transition probabilities shown in Table 1 may be represented by the following Equations 11 to 15.

$${\prod }_{{F}_{u}} = [ {π}_{{Fu}_{0} , {FuB}_{0} , Full PO} \qquad [ Equation 10 ]$$

$$⋮$$

$${π}_{{Fu}_{N} , {FuB}_{0} , Full PO}$$

$${π}_{{Fu}_{0} , {FuB}_{0} , Backup PO}$$

$$⋮$$

$${π}_{{Fu}_{0} , {FuB}_{N} , Backup PO}$$

$${π}_{{Fu}_{1} , {FuB}_{0} , Backup PO}$$

$$⋮$$

$${π}_{{Fu}_{1 ,} , {FuB}_{N - 1} , Backup PO}$$

$$⋮$$

$${π}_{{Fu}_{N} , {FuB}_{0} , Backup PO} ]$$

$${π}_{{Fu}_{0} , {FuB}_{0} , Backup PO} = {Q}_{1} {π}_{{Fu}_{0} , {FuB}_{0} , Full PO} + {Q}_{7} {\sum }_{M = 1}^{N} {π}_{{Fu}_{M} , {FuB}_{0} , Full PO} \qquad [ Equation 11 ]$$

$${π}_{{Fu}_{0} , {FuB}_{M} , Backup PO} = {Q}_{2} ( M ) {π}_{{Fu}_{0} , {FuB}_{0} , Full PO} , 1 \leq M \leq N \qquad [ Equation 12 ]$$

$${π}_{{Fu}_{M} , {FuB}_{{M}^{′}} , Backup PO} = {Q}_{8} ( {M}^{′} , M ) {π}_{{Fu}_{M} , {FuB}_{0} , Full PO} , 0 \leq {M}^{′} \leq N - M \qquad [ Equation 13 ]$$

$${π}_{{Fu}_{0} , {FuB}_{0} , Full PO} = {Q}_{3} {π}_{{Fu}_{0} , {FuB}_{0} , Backup PO} + {\sum }_{M = 1}^{N} {Q}_{5} ( 0 , M ) {π}_{{Fu}_{0} , {FuB}_{M} , Backup PO} \qquad [ Equation 14 ]$$

$${π}_{{Fu}_{J} , {FuB}_{0} , Full PO} = {Q}_{4} ( J ) {π}_{{Fu}_{0} , {FuB}_{0} , Backup PO} + {\sum }_{M = 1}^{N - J} {Q}_{5} ( J , M ) {π}_{{Fu}_{0} , {FuB}_{M} , Backup PO} + {\sum }_{M = 1}^{J} {Q}_{6} ( J - M , M ) {π}_{{Fu}_{0} , {FuB}_{M} , Backup PO} + {\sum }_{M = 1}^{J} {\sum }_{{M}^{′} = 0}^{N - M} {Q}_{9} ( J - M , {M}^{′} , M ) {π}_{{Fu}_{M} , {FuB}_{{M}^{′}} , Backup PO} + {\sum }_{M = 1}^{J} {\sum }_{{M}^{′} = 0}^{J - M} {Q}_{10} ( J - {M}^{′} - M , {M}^{′} , M ) {π}_{{Fu}_{M} , {FuB}_{{M}^{′}} , Backup PO} , 1 \leq J \leq N \qquad [ Equation 15 ]$$

A transition probability matrix Q of the semi-Markov chain is derived from the balance equations.

In addition, the transition probability matrix Q is Π_{Fu}Q=Π_{Fu} based on the definition of the steady-state distribution of the semi-Markov chain, and Π_{Fu} is derived by solving the above equations. The modeling of the paging mechanism using the semi-Markov chain according to FIG. 9 may be applied to both the paging mechanism based on the typical PO (i.e., full PO) and the fast paging mechanism based on the fast PO. In the modeling of the fast paging mechanism using the semi-Markov chain, the paging cycle changes from T to T/α (α denotes an interval between fast POs, that is, the FPCF), and the number of UEs changes from N to N′. The possible states of the semi-Markov chain for the fast paging mechanism are S_{Fu}_{_{M}}_{, FuB}_{₀}_{,Full PO}, 0≤M≤N′ and S_{Fu}_{_{M}}_{, FuB}_{_{M′}}_{,Backup PO}, 0≤M′≤N′−M, 0≤M≤N′.

The steady-state distribution of the semi-Markov chain for the fast paging mechanism may be represented by the following equation.

$${\prod }_{Fa} = [ {π}_{{Fa}_{0} , {FaB}_{0} , Full PO} \qquad [ Equation 16 ]$$

$$⋮$$

$${π}_{{Fa}_{N} , {FaB}_{0} , Full PO}$$

$${π}_{{Fa}_{0} , {FaB}_{0} , Backup PO}$$

$$⋮$$

$${π}_{{Fa}_{0} , {FaB}_{N} , Backup PO}$$

$${π}_{{Fa}_{1} , {FaB}_{0} , Backup PO}$$

$$⋮$$

$${π}_{{Fa}_{1} , {FaB}_{N - 1} , Backup PO}$$

$$⋮$$

$${π}_{{Fa}_{N} , {FaB}_{0} , Backup PO} ]$$

The balance equation for the fast paging mechanism is obtained by replacing T with T/α and N with N′ through Equation 15 in Equation 11. Then, the transition probability matrix and Π_{Fa} may be obtained in the same manner as the typical paging mechanism.

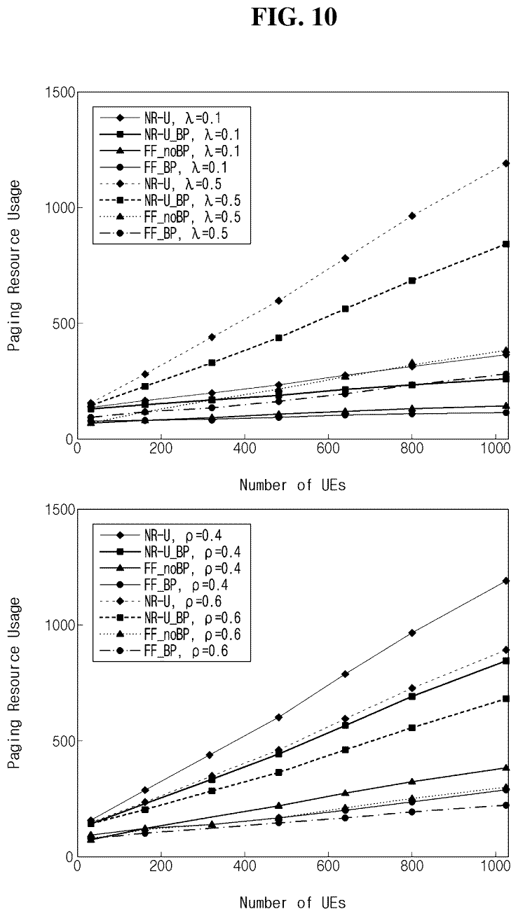

FIGS. 10 to 12 are views illustrating the results of simulating paging resource usage according to the number of UEs in various configurations including the paging mechanism according to the embodiment of the present disclosure.

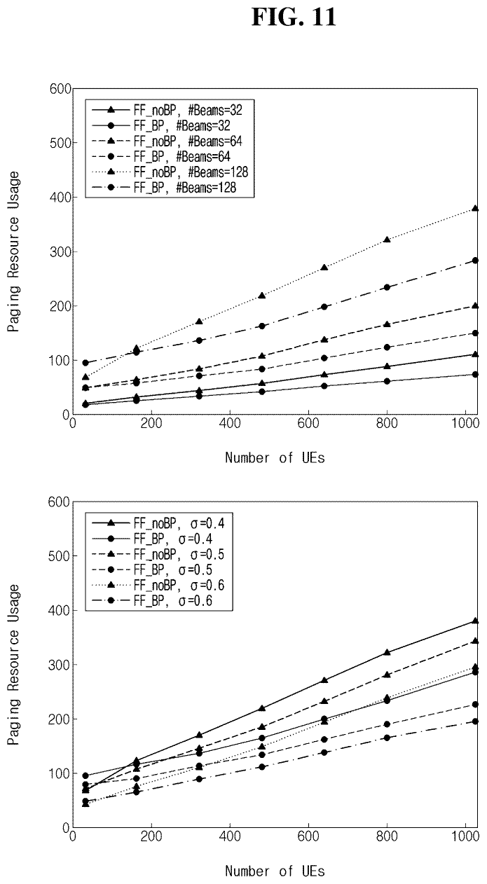

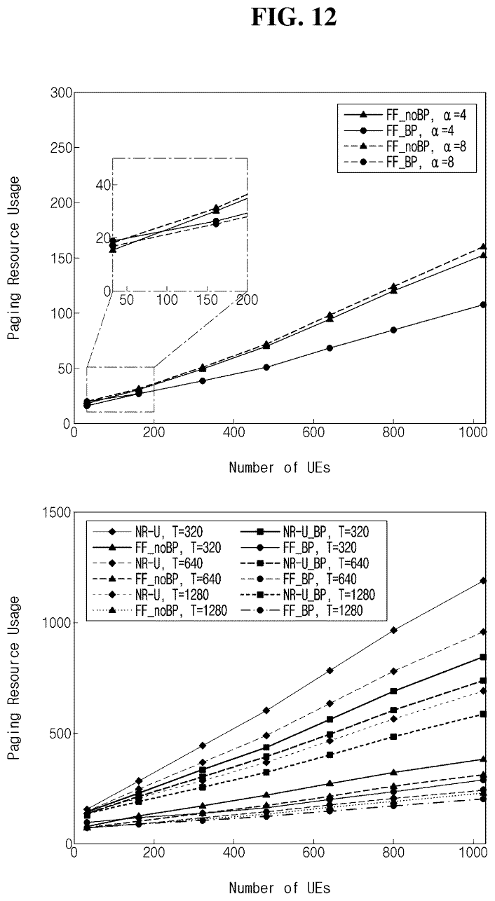

FIG. 10A illustrates the results according to changes in a paging arrival rate, FIG. 10B illustrates the results according to changes in a downlink LBT success probability, FIG. 11A illustrates the results according to changes in the number of beams, FIG. 11B illustrates the results according to changes in a ratio of delay-sensitive UEs, FIG. 12A illustrates the results according to changes in FPCFs, and FIG. 12B illustrates the results according to changes in a typical full paging cycle. As can be seen in FIGS. 10 to 12, when a full-fast paging with backup PO (FF_BP), which is a paging mechanism according to the embodiment of the present disclosure, is used under the same conditions, good performance is achieved in most indicators.

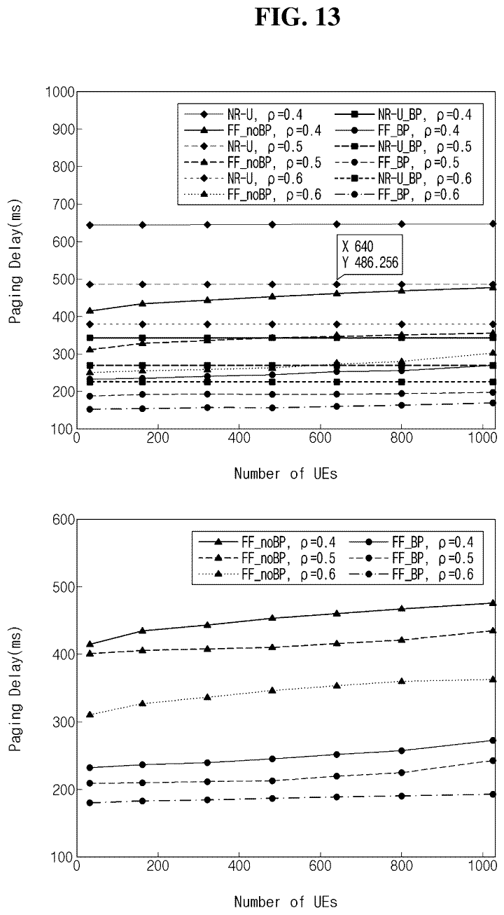

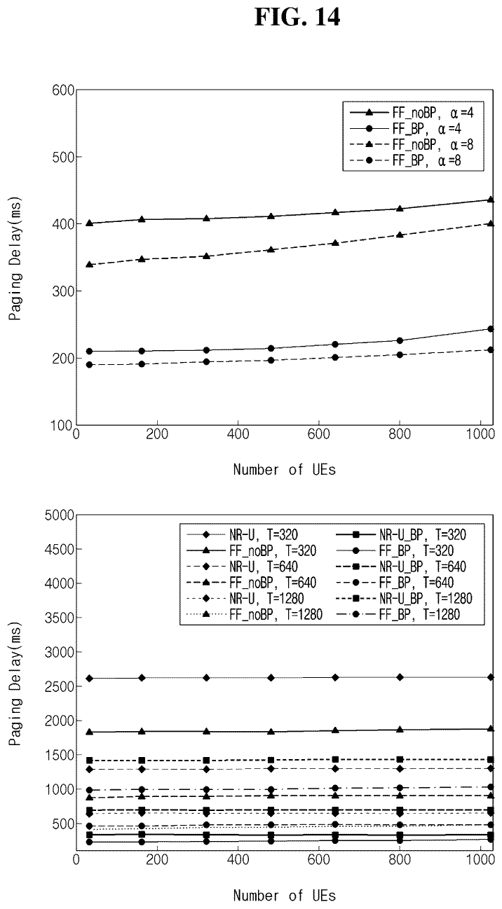

FIGS. 13 and 14 are views illustrating the results of simulating paging delay usage according to the number of UEs in various configurations including the paging mechanism according to the embodiment of the present disclosure.

FIG. 13A illustrates the results according to changes in a downlink LBT success probability, FIG. 13B illustrates the results according to changes in a ratio of delay-sensitive UEs, FIG. 14A illustrates the results according to changes in a fast paging cycle coefficient, and FIG. 14B illustrates the results according to changes in a typical full paging cycle. FIGS. 13 and 14 also illustrate that, under the same conditions, when the paging mechanism “FF_BP” according to the embodiment of the present disclosure is used, good performance is achieved in most indicators.

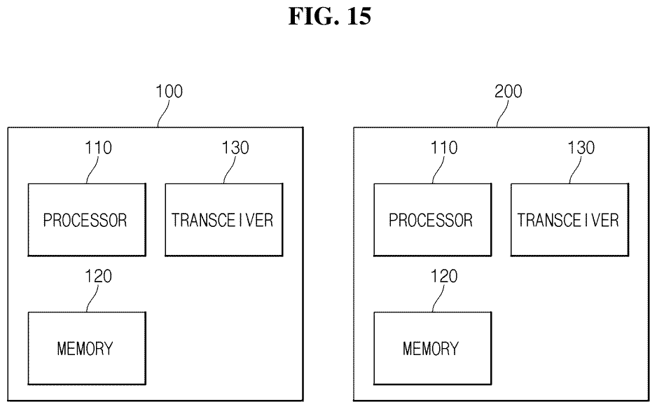

FIG. 15 is a block diagram illustrating a BS and a UE according to the embodiment of the present disclosure and reconstructs a method performed by each of the BS and the UE according to the embodiment of the present disclosure from the perspective of hardware configuration. To avoid overlapping descriptions, only a brief overview of the operations and functions of each component will be provided.

Referring to FIG. 15, a BS 100 for transmitting a paging message in an NR-U environment may include one or more processors 110 and one or more memories 120 and further include one or more transceivers 130 and/or one or more antennas. The processor 110 and the memory 120 may be electrically connected, directly or indirectly, and the memory 120 may store instructions for operations executed by the processor 110. The transceiver 130 may be connected to the processor 110 and may transmit and/or receive wireless signals via the one or more antennas. The transceiver 130 may include a transmitter and/or a receiver.

In the processor 110, the operations may include scheduling a PO according to a DRX cycle of a UE, transmitting DRX-related information including a PO and a PF to the UE, transmitting a paging message to the UE based on the DRX-related information, and scheduling a next PO based on the PO. The next paging occasion may include a backup PO scheduled by the BS after maximum channel occupancy time (MCOT) has elapsed after the PO, when the UE fails to receive the paging message during the PO.

Among the operations performed by the processor 110, the scheduling of the PO may include determining, using a discrete-time semi-Markov chain, UEs that require paging or backup paging at the next PO based on the PO immediately before the next PO.

Among the operations performed by the processor 110, the scheduling of the next PO may further include receiving beam information from the UE immediately before the next PO, scheduling a fast PO based on the PO and the beam information, and transmitting a fast paging message to the UE based on the fast PO. In this case, the beam information may include at least one of RSRP, RSRQ, and SINR.

Among the operations performed by the processor 110, the scheduling of the next PO may further include scheduling a backup fast PO after the MCOT has elapsed after the fast PO, when the UE fails to receive the fast paging message during the fast PO.

In another embodiment, the fast paging message may be transmitted to the UE through the beam selected based on the beam information.

Referring to FIG. 15, a UE 200 for receiving the paging message in the NR-U environment may include one or more processors 210 and one or more memories 220 and further include one or more transceivers 230 and/or one or more antennas. The processor 210 and the memory 220 may be electrically connected, directly or indirectly, and the memory 220 may store instructions for operations executed by the processor 210. The transceiver 230 may be connected to the processor 210 and may transmit and/or receive wireless signals via the one or more antennas. The transceiver 230 may include a transmitter and/or a receiver.

In the processor 210, the operations may include receiving, from the BS, DRX-related information including information on a PO and a PF through radio resource control (RRC) signaling, receiving a paging message from the BS based on the DRX-related information, and receiving a next paging message from the BS according to a next PO scheduled based on the PO. In this case, the next PO may include a backup PO scheduled by the BS after the MCOT has elapsed since the PO, when the paging message is not received during the PO, and the next paging message may include a backup paging message received from the BS based on the backup PO.

Among the operations performed by the processor 210, the receiving of the next paging message from the BS may further include transmitting beam information to the BS immediately before the next PO, and receiving a fast paging message from the BS according to a fast PO scheduled based on the PO and the beam information. In this case, the beam information may include at least one of RSRP, RSRQ, and SINR.

Among the operations performed by the processor 210, the receiving of the next paging message from the BS may further include receiving, from the BS, a backup fast paging message according to a backup fast PO scheduled by the BS after the MCOT has elapsed after the fast PO, when the UE fails to receive the fast paging message during the fast PO.

According to another embodiment, the fast paging message may be received from the BS through the beam selected by the BS based on the beam information.

Meanwhile, a computer-readable recording medium according to the embodiment of the present disclosure may record a program for executing a method performed by the BS and a method performed by the UE according to the embodiment of the present disclosure on a computer. The computer-readable recording media include all types of recording devices that store data readable by a computer system.

Examples of the computer-readable recording media include a ROM, a RAM, a CD-ROM, a magnetic tape, a floppy disk, optical data storage devices, etc. In addition, the computer-readable recording media may be amortized across a network-connected computer system to allow the computer-readable code to be stored and executed in an amortized manner.

The present disclosure has been described above with reference to various embodiments thereof. Those skilled in the art to which the present disclosure pertains will be able to understand that various embodiments may be implemented in a modified form without departing from the essential characteristics of the present disclosure. Accordingly, the disclosed embodiments should be considered in an illustrative rather than a limiting sense. The scope of the present disclosure is described in the claims rather than the above description, and all differences in the equivalent scope should be construed as being included in the present disclosure.

What is claimed is:

1. A method of transmitting a paging message in a new radio-unlicensed (NR-U) environment, which is performed by a base station (BS), the method comprising:
scheduling a paging occasion (PO) according to a discontinuous reception (DRX) cycle of user equipment (UE);
transmitting DRX-related information including information about the PO and a paging frame (PF) to the UE through radio resource control (RRC) signaling;
transmitting a paging message to the UE based on the DRX-related information; and
scheduling a next PO based on the PO,
wherein the next PO includes a backup PO scheduled by the BS after maximum channel occupancy time (MCOT) has elapsed after the PO, when the UE fails to receive the paging message during the PO.

2. The method of claim 1, wherein the scheduling of the next PO includes determining, through a discrete-time semi-Markov chain, whether paging or backup paging is required for the UE at the next PO based on the PO immediately before the next PO.

3. The method of claim 1, wherein the scheduling of the next PO further includes:
receiving beam information from the UE immediately before the next PO;
scheduling a fast PO based on the PO and the beam information; and
transmitting a fast paging message to the UE based on the fast PO, and
the beam information includes at least one of reference signal received power (RSRP), reference signal received quality (RSRQ), and a signal to interference plus noise ratio (SINR).

4. The method of claim 3, wherein the scheduling of the next PO further includes scheduling a backup fast PO after the MCOT has elapsed after the fast PO, when the UE fails to receive the fast paging message during the fast PO.

5. The method of claim 3, wherein the fast paging message is transmitted to the UE through a beam selected based on the beam information.

6. A base station (BS) for transmitting a paging message in a new radio-unlicensed (NR-U) environment, the BS comprising:
one or more transceivers;
one or more processors; and
one or more memories configured to store instructions for operations executed by the processors,
wherein the operations include:
scheduling a paging occasion (PO) according to a discontinuous reception (DRX) cycle of user equipment (UE);
transmitting DRX-related information including information about the PO and a paging frame (PF) to the UE through radio resource control (RRC) signaling;
transmitting a paging message to the UE based on the DRX-related information; and
scheduling a next PO based on the PO, and
the next PO includes a backup PO scheduled by the BS after maximum channel occupancy time (MCOT) has elapsed after the PO, when the UE fails to receive the paging message during the PO.

7. The BS of claim 6, wherein the scheduling of the next PO includes determining, through a discrete-time semi-Markov chain, whether paging or backup paging is required for the UE at the next PO based on the PO immediately before the next PO.

8. The BS of claim 6, wherein the scheduling of the next PO includes:
receiving beam information from the UE immediately before the next PO;
scheduling a fast PO based on the PO and the beam information; and
transmitting a fast paging message to the UE based on the fast PO, and
the beam information includes at least one of reference signal received power (RSRP), reference signal received quality (RSRQ), and a signal to interference plus noise ratio (SINR).

9. The BS of claim 8, wherein the scheduling of the next PO further includes scheduling a backup fast PO after the MCOT has elapsed after the fast PO, when the UE fails to receive the fast paging message during the fast PO.

10. The BS of claim 8, wherein the fast paging message is transmitted to the UE through a beam selected based on the beam information.

11. A method of receiving a paging message in a new radio-unlicensed (NR-U) environment, which is performed by user equipment (UE), the method comprising:
receiving discontinuous reception (DRX)-related information including information about a paging occasion (PO) and a paging frame (PF) from a base station (BS) through radio resource control (RRC) signaling;
receiving a paging message from the BS based on the DRX-related information; and
receiving a next paging message from the BS according to a next PO scheduled based on the PO,
wherein the next PO includes a backup PO scheduled by the BS after maximum channel occupancy time (MCOT) has elapsed after the PO, when the UE fails to receive the paging message during the PO, and
the next paging message includes a backup paging message received from the BS based on the backup PO.

12. The method of claim 11, wherein the receiving of the next paging message from the BS further includes:
transmitting beam information to the BS immediately before the next PO; and
receiving a fast paging message from the BS according to a fast PO scheduled based on the PO and the beam information, and
the beam information includes at least one of reference signal received power (RSRP), reference signal received quality (RSRQ), and a signal to interference plus noise ratio (SINR).

13. The method of claim 12, wherein the receiving of the next paging message from the BS further includes:
receiving a backup fast paging message from the BS according to a backup fast PO scheduled by the BS after the MCOT has elapsed after the fast PO, when the UE fails to receive the fast paging message during the fast PO.

14. The method of claim 12, wherein the fast paging message is received from the BS through a beam selected by the BS based on the beam information.

15. User equipment (UE) for receiving a paging message in a new radio-unlicensed (NR-U) environment, the UE comprising:
one or more transceivers;
one or more processors; and
one or more memories configured to store instructions for operations executed by the processors,
wherein the operations include:
receiving discontinuous reception (DRX)-related information including information about a paging occasion (PO) and a paging frame (PF) from a base station (BS) through radio resource control (RRC) signaling;
receiving a paging message from the BS based on the DRX-related information; and
receiving a next paging message from the BS according to a next PO scheduled based on the PO,
the next PO includes a backup PO scheduled by the BS after maximum channel occupancy time (MCOT) has elapsed after the PO, when the UE fails to receive the paging message during the PO, and
the next paging message includes a backup paging message received from the BS based on the backup PO.

16. The UE of claim 15, wherein the receiving of the next paging message from the BS further includes:
transmitting beam information to the BS immediately before the next PO; and
receiving a fast paging message from the BS according to a fast PO scheduled based on the PO and the beam information, and
the beam information includes at least one of reference signal received power (RSRP), reference signal received quality (RSRQ), and a signal to interference plus noise ratio (SINR).

17. The UE of claim 16, wherein the receiving of the next paging message from the BS further includes:
receiving a backup fast paging message from the BS according to a backup fast PO scheduled by the BS after the MCOT has elapsed after the fast PO, when the UE fails to receive the fast paging message during the fast PO.

18. The UE of claim 16, wherein the fast paging message is received from the BS through a beam selected by the BS based on the beam information.
